(19) United States
(12) Patent Application Publication
(10) Pub. No.: US 2009/0006177 A1
(43) Pub. Date: Jan. 1, 2009

(54) PROVIDING ADS TO UNCONNECTED CLIENT DEVICES

(75) Inventors: John A. BEAVER, Kirkland, WA (US); Brian E. TSCHUMPER, Woodinville, WA (US); Prasanth PULAVARTHI, Bothell, WA (US); Wenjun QIU, Bothell, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 11/770,409

(22) Filed: Jun. 28, 2007

(51) Int. Cl. G06F 19/00

(52) U.S. Cl. 705/10; 70/89

(57) ABSTRACT

Techniques are disclosed, among other things, that provide ads to requesting applications while the client device is not connected to a communication network. An offline advertisement engine is provided for storing business rules for each of a plurality of corresponding stored advertisements, wherein the business rules and advertisements are stored locally on the client device. An offline advertisement media manager is also provided for storing creatives related to the stored advertisements, wherein the creatives are also stored locally on the client device. Moreover, an advertisement center client is disclosed for providing advertisements and creatives associated with the advertisement to an application in response to a request for the advertisements.

### CROSS-REFERENCE TO RELATED APPLICATION

Not applicable.

### STATEMENT REGARDING FEDERALLY SPONSORED RESEARCH OR DEVELOPMENT

Not applicable.

### BACKGROUND

Current digital advertisement delivery requires network connectivity at ad display time. Generally, the network connectivity is used for: advertisement selection including applying business rules on a server for the server to pick an advertisement to show; advertisement retrieval including retrieving an image or other item of multimedia data to display with an advertisement; and advertisement eventing including tracking that an advertisement was viewed or interacted with by a user.

This current model of advertisement delivery is acceptable for websites because network connectivity is a pre-condition in visiting the website. However, there can be instances, as with mobile communication devices, in which network connectivity at an application's ad display time is not practical or feasible. Such devices may either have network connectivity only for some periods of time (i.e. WiFi hotspots) or have user experience performance requirements that preclude connecting over a communication network at the time of ad display. Accordingly, there exists a need to deliver advertisements to devices that have network connectivity on a part-time basis without requiring the device to have network connectivity at ad display time.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques are disclosed, among other things, that provide ads to requesting applications within a client device when the client device is not connected to a communication network. When a request is received for an advertisement while the client device does not have network connectivity, a set of business rules are accessed to determine which advertisement best meets the needs of the request. The business rules and the advertisements are typically stored locally on the client device. Once a qualified advertisement has been identified, the qualified advertisement is retrieved from its local storage medium and is provided to the requesting application. Once the application obtains the advertisement, the application can in turn display the advertisement to a user.

### BRIEF DESCRIPTION OF THE DRAWINGS

Illustrative embodiments of the present invention are described in detail below with reference to the attached drawing figures, which are incorporated by reference herein and wherein:

FIG. 1 is a block diagram of an exemplary system for implementing an embodiment of the invention.

FIG. 2 illustrates a block diagram of an exemplary offline ad engine according to an embodiment of the invention.

FIG. 3 is a flow diagram of an exemplary method for providing ads to requesting applications while the client device is not connected to a communication network according to an embodiment of the invention.

FIG. 4 is a flow diagram of another exemplary method for providing ads to requesting applications while the client device is not connected to a communication network according to an embodiment of the invention.

### DETAILED DESCRIPTION

As one skilled in the art will appreciate, embodiments of the present invention may be embodied as, among other things: a method, system, or computer-program product. Accordingly, the embodiments may take the form of a hardware embodiment, a software embodiment, or an embodiment combining software and hardware. In one embodiment, the present invention takes the form of a computer-program product that includes computer-useable instructions embodied on one or more computer-readable media.

Computer-readable media include both volatile and nonvolatile media, removable and nonremovable media, and contemplates media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. An exemplary modulated data signal includes a carrier wave or other transport mechanism. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

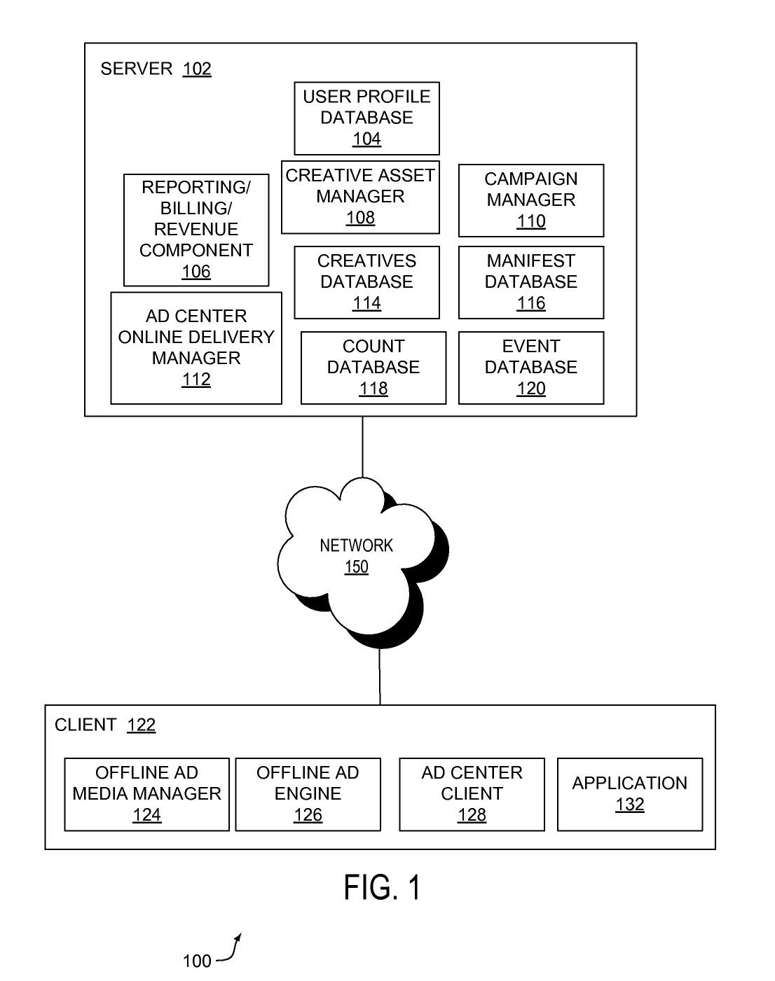

FIG. 1 is a block diagram of an exemplary system 100 for implementing an embodiment of the invention. The system 100 includes server 102, client 122, and network 150. Server 102 and client 122 are devices that each include a communication interface. The communication interface may be an interface that can allow a device to be directly connected to any other device or allows the device to be connected to another device over network 150. Network 150 can include, for example, a local area network (LAN), a wide area network (WAN), a cellular phone network, or the Internet. In an embodiment, a device can be connected to another device via a wireless communication interface through the network 150.

Server 102 may also be or can include a workstation running the Microsoft Windows®, MacOS™, Unix™, Linux, Xenix™, IBM AIX™, Hewlett-Packard UX™, Novell Netware™, Sun Microsystems Solaris™, OS/2™, BeOS™, Mach™, Apache™, OpenStep™ or other operating system or platform. In an embodiment, server 102 is an advertisement (ad) management server for managing the delivery of digital ads to users of clients 122.

Server 102 includes: user profile database 104; reporting/billing/revenue sharing component 106; creatives asset manager 108; campaign manager 110; ad center online delivery manager 112; creatives database 114; manifest database 116; count database 118; and event database 120. In an embodiment, one or more of components 104, 106, 108, 110, 112, 114, 116, 118, and 120 may be integrated within one or more other servers. Ad center online delivery manager 112 is a computer hardware or software component that is utilized to manage the placement of ads on websites. In an embodiment, the ad center online delivery manager 112 is also utilized to manage the distribution of ads for client applications while the client 122 is connected to server 102 via a communication network such as the Internet. Campaign manager 110 is a computer hardware or software component that is used to create and store a set of business rules associated with each ad. An ad's set of business rules outlines the manner in which an advertiser would like its ad displayed to users and/or what constitutes as an interaction with the ad by the user. For example, a set of business rules can define when to start serving the ad to users, when to stop serving the ad, the number of times the ad should be delivered to users, the percentage of time an ad should be delivered amongst all ads displayed within a given ad space, the actions a user needs to take in order for the ad to be served to the user, the type of users that should be targeted by the ad, what constitutes an impression, the number of impressions that should be delivered for an ad, and the percentage of impressions that should be delivered amongst all impressions delivered for a given location. An impression is a unit of ad delivery, in other words, when the ad is considered to be delivered to a user. The business rules can define what the unit of ad delivery will be for each ad. For example, an impression can be established when an ad is displayed to a user, when a user clicks on an ad, when a threshold amount of time has elapsed before the user disables the ad, or when a user rates the ad or provides another form of feedback regarding the ad. The business rules may be negotiated, for example, between the advertiser that created the ad and the entity managing server 102. Once the set of business rules has been created for an ad, the business rules are associated and stored with the ad, or with an identifier of the ad (ad id), in a database accessible to the campaign manager 110.

Creatives asset manager 108 is a computer hardware or software component that is utilized to manage an ad's creatives. A creative is image content, video content, audio content, or any other item of multimedia content that is associated with the ad. Advertisers can upload creatives associated with each of their ads to the creatives asset manager 108. Once the creatives are received, the creatives asset manager 108 can publish the creatives of an ad to front end servers that a client device can go to in order to download the creatives. The creatives asset manager 108 can also associate and store the creatives with the corresponding ad, or ad id, within creatives database 114.

Manifest database 116 stores the manifest associated with each client application. A manifest is created for a particular client application of a client device 122 and contains the ads that can be displayed on the client, the ads' associated business rules, and pointers to the locations of each ad's creatives. The types of ads that are placed in the manifest for a client device may be based on the attributes of the client device. Such attributes may include, but are not limited to, the capabilities of the client and the types of applications that can request ads on the client. The types of ads that are placed in the manifest for a client device may also be based on the attributes of a particular client application. Such attributes may include, but are not limited to, keywords from a document associated with the application, wherein the types of ads placed in the manifest are related to the keywords. Moreover, a client device may submit one or more identifiers to campaign manager 110 that detail the attributes of the client device and/or the client application. The campaign manager 110 may be configured to access a look-up table that details the types of ads that can be given to client devices based on the particular identifiers. In another embodiment, the campaign manager 110 can determine on-the-fly what ads can be given to the client device based on the received identifiers.

The campaign manager 110 can also access user profile database 104 to determine which ads to give a client device. The user profile database 104 can include demographic information of a plurality of users as well as behavioral targeting attributes of the users. The user profile database can associate the demographic information and/or the behavioral targeting attributes with an identifier of each user. A client device may submit the identifier along with the request for the manifest. The campaign manager 110 may decide to populate a manifest with certain ads that are relevant to the demographic information and/or the behavioral targeting attributes. For example, if campaign manager 110 determines from the user profile database 104 that the user related to the requesting client device is a male from Washington, the campaign manager 110 can include ads that are targeted to males in Washington in a manifest for the client device. Alternatively, the location of the user can be determined on-the-fly by via the IP address of the user's client device.

Once the campaign manager 110 determines which ads it would like to give to the client, the campaign manager 110 can create a manifest for the client and can store the manifest in the manifest database 116. The stored manifest can then be accessed by a client device. After a manifest has been created and stored, the campaign manager 110 can also be configured to update the manifest with new information in the future.

Count database 118 is used to keep record of a global impression count of the number of impressions that have been identified on all client devices within a community. The count database 118 is also utilized to keep record of a global view count for all ads that can be displayed on client devices within a community. A view count of an ad is the number of times the ad is qualified to be shown in response to an application's request for an ad. An ad is qualified to be shown if its business rules meet the requirements of the application's request. In an embodiment, the community can be as large as all client devices found in the entire world. In another embodiment, the community can be any subset of all client devices found in the entire world. Each client device can be configured to periodically upload events corresponding to a local impression count and a local view count for each ad to event database 120 when the client device is connected to a communication network such as the Internet. Additionally, each client device can be configured to store a local impression count and local view count for each ad when the client device is not connected to a communication network. When the client device eventually connects to the communication network, the client device can be configured to upload the events corresponding the stored local impression count and local view count for each ad to the event database 118. Each time a client device uploads an event corresponding to a local impression count and/or local view count to the event database 120, the global impression count and global view count are respectively incremented in the count database 118 for that particular ad according to the local counts received.

Events database 120 stores events that have been reported back from a client device. An event describes the way in which a user interacted with an ad that was served to him/her on the client device. An event can describe, for example: whether the ad was served to a user; whether the user clicked on the ad; whether the user played the ad in instances where the ad comprises video content; the amount of time the user let the ad display or run before disabling the ad; whether the user rewound the ad so that it could replay; whether the user rated the ad; the rating the user gave the ad, and any other event that can lead to incrementing the local impression or view count. A client device can be configured to store the event locally in instances when it is not connected to a communication network, and can upload the event to events database 120 once the client device is connected to a communication network. Moreover, events stored in events database 120 can be reported to reporting/billing/revenue sharing component 106 for third-party reporting, billing, or revenue generating purposes.

Client 122 may be or can include a desktop or laptop computer, a network-enabled cellular telephone (with or without media capturing/playback capabilities), wireless email client, or other client, machine or device to perform various tasks including Web browsing, search, electronic mail (email) and other tasks, applications and functions. Client 122 may additionally be any portable media device such as digital still camera devices, digital video cameras (with or without still image capture functionality), media players such as personal music players and personal video players, and any other portable media device. Client 122 may also be or can include a server such as a workstation running the Microsoft Windows®, MacOS™, UniX™, Linux, Xenix™, IBM AIX™, Hewlett-Packard UX™, Novell Netware™, Sun Microsystems Solaris™, OS/2™, BeOS™, Mach™, Apache™, OpenStep™ or other operating system or platform.

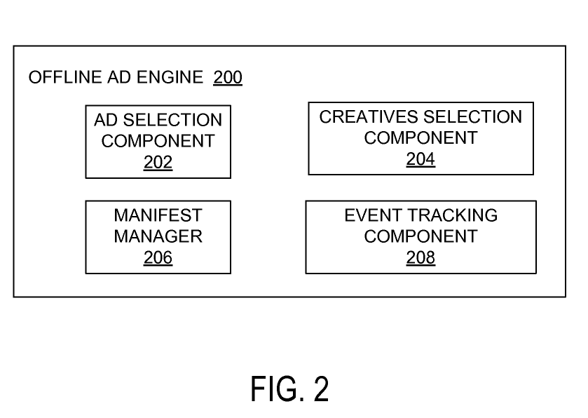

Client 122 includes offline ad media manager 124, offline ad engine 126, and ad center client 128. In an embodiment, one or more of the offline ad media manager 124, offline ad engine 126, and ad center client 128 may be integrated into one component. FIG. 2 illustrates a block diagram of an exemplary offline ad engine 200 according to an embodiment of the invention. Offline ad engine 200 is a hardware or software component that is utilized to manage manifests downloaded from server 102, the selection of ads to be served to a user, the selection of creatives that need to be included with an ad, and the events created by a user's interaction with an ad. Offline ad engine 200 includes ad selection component 202, creatives selection component 204, manifest manager 206, and event tracking component 208. Event tracking component 208 is utilized to monitor and store any events associated with the manner in which a user interacts with a served ad. In an embodiment, the events are stored in the event tracking component 208 when the client device is not connected to a communication network. The event tracking component 208 is also configured to upload any stored events to events database 120 when the client device is connected to a communication network.

Manifest manager 206 is utilized to store manifests downloaded from manifest database 116. The manifest manager can also download updates to any previously-downloaded manifests. In an embodiment, the manifest manager may include one or more first-run manifests. A first-run manifest is a manifest that is initially included and pre-installed with the offline ad engine 200. The first-run manifest provides the same types of elements of a manifest created by a campaign manager without requiring the client device to connect to a communication network to download the manifest. Moreover, the manifest manager 208 can periodically download new manifests and updates to previously-downloaded manifests from manifest database 116 while the client device is connected to a communication network.

Creatives selection component 204 communicates with manifest manager 206 to determine what creatives need to be downloaded for each ad within each stored manifest. Creatives selection component 204 communicates, to the offline ad media manager 124 (FIG. 1), the location of each creative that needs to be downloaded. Creative selection component 204 also communicates with the manifest manager 206 to identify when each downloaded creative needs to deleted or updated. This identified information can be found, for example, within the business rules of each ad's manifest. The creatives selection component 204 can instruct the offline ad media manager 124 to delete certain creatives from the offline ad media manager's database. The creative selection component 204 can also instruct the offline ad media manager 124 to download an updated version of a previously-downloaded creative. While the client device is connected to a communication network, the creative selection component 204 can periodically instruct the offline ad media manager 124 to download and store new creatives or updates to previously-downloaded creatives.

Ad selection component 202 communicates with the manifest manager 206 to determine which ad to provide to a requesting application. The requesting application may provide a set of requirements that an ad must meet. The requirements can include, but is not limited to, format and size information of a desired ad, the attributes of the client 122, and the attributes of the requesting application. The ad selection component 202 can review the business rules associated with each ad and can determine which ads meet the application's requirements while fulfilling their business rules. Once the ad selection component 202 determines the appropriate ad for the application, the ad selection component 202 can provided the determined ad from the manifest manager to the requesting application. The ad selection component 202 can also instruct the creatives selection component 204 to retrieve the corresponding creatives for the determined ad. Upon such instruction, the creative selection component 204 can instruct the offline ad media manager to retrieve any creatives corresponding to the determined ad. In an embodiment, the ad selection component 202 can directly instruct the offline ad media manager 124 to provide the corresponding creatives to the requesting application.

Ad selection component 202 is also configured to detect impressions created by users interacting with ads. The ad selection component 202 can first communicate with manifest manager 206 to determine what constitutes an impression for each ad from the business rules. The ad selection component can also be configured to store a local count of the number of impressions identified for each ad. The ad selection component 202 can also be configured to detect when an ad is qualified to be displayed in response to an application's request for an ad. The ad selection component 202 can communicate with the manifest manager to determine if an ad is qualified to be displayed by evaluating whether an ad's business rules meets the requirements of the application's request. In an embodiment, if a qualified ad cannot be found in the manifest manager 206 and the client device is not connected to a communication network, then the ad selection component 202 can be configured to provide a default ad in response to the application's request.

The ad selection component 202 can periodically communicate with the event tracking component 208 to upload the events corresponding to the stored local impression count and local view count into the event database 120 whenever the client device is connected to a communication network. By uploading such events into the event database 120, the global impression count and global view count are respectively updated and incremented in the count database 118 for each ad. The ad selection component 202 can also be configured to periodically download the global impression count and global view count for each locally stored ad when the client device is connected to a communication network.

In an embodiment, the ad selection component 202 can utilize the local impression count, the global impression count, the local view count, and the global view count of each ad to determine when to provide an ad in response to an application's request. For example, when there are multiple ads that have qualifications to be provided in response to an application's request, the ad selection component 202 can review each qualified ad's business rules to determine if each ad has met its impression goal at the time the request is receive. This determination is accomplished by comparing an estimated total global impression count (ETGIC) value to the ad's expected impression count at the time of the request, wherein the expected impression for the particular moment in time can be defined in the business rules. The estimated total global count can be calculated using the following algorithms:

(ETGIC)=global impression count+(local impression count*weight) (1)

Weight=(Δglobal view count/Δlocal view count) (2)

Algorithm (1) states that the estimated total global count equals the global impression count added with the product of the local impression count and a weight value. In algorithm (1), the global impression count is the last global impression count that was downloaded by the client device. The last downloaded global impression count can be obtained from the ad selection component 202. Furthermore, the local impression count in algorithm (1) is equivalent to the number of impressions identified and stored by the client device since the last time the global impression count was downloaded to the client device.

Because of the potential large number of client machines serving the ads, the local impression count may be almost negligible when compared to the global impression count if the two impression counts were simply added together by themselves to get the estimated total global count. This is a reason why the weight value is included in algorithm (1). As shown in algorithm (2), the weight value in algorithm (1) is calculated by dividing the global view count change by the local view count change in the same period of time. In an embodiment, the global view count change is calculated by subtracting a previously-stored global view count on the client device from the last global view count downloaded by the client device. The local view count change can be calculated by subtracting the local view count, that corresponds to the time when the previously-stored global view was stored on the client device, from the local view count that corresponds to the time when the last global view count was downloaded to the client device. Once the weight value is calculated, the weight value can be inserted into algorithm (1) in order to complete the calculation of the estimated total global impression count.

The weight value tells the proportion of the global traffic to the local traffic for the condition group that ad is targeted for. The value of “local impression count * weight” helps give an estimate of the global impression count increase since the last time the global impression count was downloaded. The weight value helps the client devices deliver ads evenly across synchronization periods and reduce the chances of over delivery during prolonged offline periods. In an embodiment, if an ad's ETGIC exceeds the expected impression count, then the particular ad will not be served over another ad who's ETGIC does not exceed its expected impression count. In an embodiment, multiple ads that are qualified to be served in response to an application's request will be ranked in an order based on how far away an ad's ETGIC is from reaching the ad's respective expected impression count for the moment in time the request is received. For example, an ad whose ETGIC is the farthest away from the ad's expected impression count will be prioritized before all other ads when it comes to providing the ad in response to an application's request for an ad.

Referring back to FIG. 1, offline media manager 124 is computer hardware or software component that is utilized to download and store creatives associated with corresponding ads. Upon instruction by the offline ad engine 126, the offline media manager 124 can download certain creatives from creatives database 114 once it receives the locations of the creatives that need to be downloaded. The offline media manager can also be configured to download updates to previously-stored creatives and delete creatives upon instruction from the offline ad engine 126. In an embodiment, the offline media manager 124 can be configured to drive the offline ad engine's manifest download and event reporting functionality.

The ad center client 128 provides an application program interface (API) that interfaces with a requesting applications 132 so that the application 132 can convey a request for ads from the offline ad engine 126. The ad center client 128 is also configured to detect if there is connectivity to a communication network and to communicate with the offline ad media manager to determine which ads are available locally on the client device.

Once a manifest has been downloaded by the offline ad engine 126 (or a first run manifest is available within the offline ad engine 126) and the creatives corresponding to the ads listed in the manifest have been downloaded and stored, the client device 122 can begin to provide advertisements to applications 132 even when the client device is not connected to a communication network. For example, the application 132 can make a request for an ad by communicating the request to the ad center client 128. The ad center client can then forward the request to the offline ad engine for further processing. The offline ad engine can review the requirements of the request and can search through the manifest manager 206 (FIG. 2) to determine if there are any qualified ads based on the ads' business rules and other attributes. Once a qualified ad is identified, the offline ad media manager can be contacted in order to retrieve the creatives associated with the identified ad. In an embodiment, if more that one qualified ad is identified, algorithms (1) and (2), as described above, may be utilized in order to pick an ad amongst the multiple qualified ads. Once the creatives are retrieved, the ad and corresponding creatives are returned to the requesting application 132 in order to be displayed to a user. The user's interaction with the ad is monitored, and any local impression counts, local view counts, and/or events created because of the interaction are stored in offline ad engine 126.

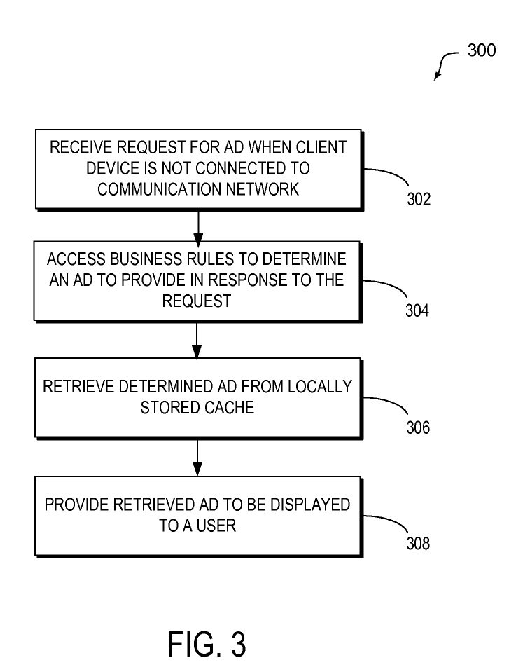

FIG. 3 is a flow diagram of an exemplary method 300 for providing ads to requesting applications while the client device is not connected to a communication network according to an embodiment of the invention. At operation 302, a request is received for an advertisement from an application when the client device is not connected to a communication network. In an embodiment, the request will include one or more requirements needed of the advertisement. At operation 304, business rules are accessed to determine if there's a qualified advertisement to provide in a response to the request. In an embodiment, the business rules are stored locally on the client device. At operation 306, a cache of a plurality of advertisements is accessed to retrieve the determined advertisement. In an embodiment, the plurality of advertisements are stored locally on the client device. At operation 308, the determined advertisement is provided to be displayed to a user.

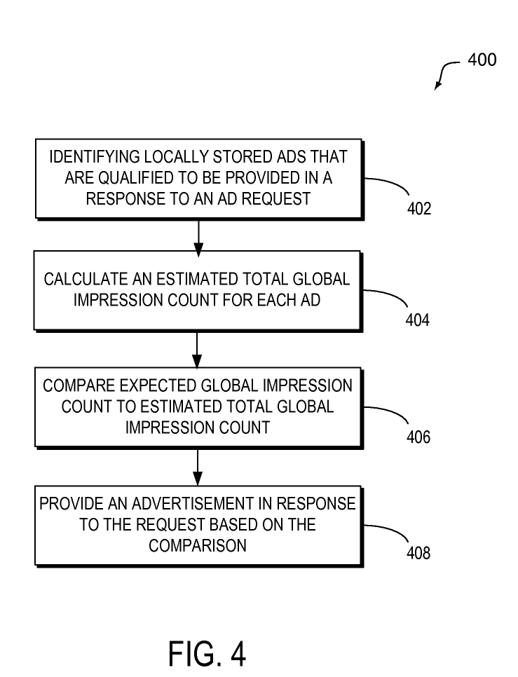

FIG. 4 is a flow diagram of another exemplary method 400 for providing ads to requesting applications while the client device is not connected to a communication network according to an embodiment of the invention. At operation 402, a plurality of advertisements stored locally on a client machine are identified as being qualified to be provided in a response to a request from an application. In an embodiment, the qualified advertisements are determined by comparing the requirements of the request to one or more business rules of each of the plurality of advertisements. At operation 404, an estimated total global impression count is calculated for each advertisement within the plurality of advertisements. At operation 406, an expected impression count of each advertisement is compared to the corresponding estimated total global impression count of the advertisement. In an embodiment, the expected impression count is retrieved from the business rules related to each advertisement. At operation 408, an advertisement is provided based on the comparison of the expected impression count to the total global impression count.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

We claim:

1. A method for providing advertisements to requesting applications while the client device is not connected to a communication network, comprising:
receiving a request for an advertisement from an application when the client device is not connected to a communication network;
accessing one or more business rules to determine at least one advertisement to provide in response to the request, wherein the one or more business rules are stored locally on the client device;
accessing a cache of a plurality of advertisements to retrieve the at least one advertisement, wherein the plurality of advertisements are stored locally on the client device; and
providing the at least one advertisement to be displayed to a user.

2. The method according to claim 1, further comprising storing one or more events locally on the client device, the one or more events being associated with one or more ways in which the user interacts with the displayed advertisement.

3. The method according to claim 2, wherein the one or more events are stored locally when the client device is not connected to a communication network.

4. The method according to claim 3, further comprising reporting the one or more events to at least one server when the client device is connection to a communication network.

5. The method according to claim 1, further comprising periodically downloading at least one of new business rules, updates to previously-stored rules, new advertisements, and previously-stored advertisements when the client device is connected to a communication network.

6. The method according to claim 1, further comprising, when it is determined that a plurality of advertisements are qualified to fulfill the request, calculating an estimated total global impression count for each advertisement within the plurality of advertisements and comparing an expected impression count of each advertisement to the estimated total global impression count.

7. The method according to claim 6, further comprising ranking the plurality of advertisements in an order that depends on how far away the estimated total global impression count is from reaching the expected impression count, wherein the advertisements that are furthest away from reaching the expected impression count are ranked higher.

8. The method according to claim 7, further comprising providing the highest ranked advertisement to be displayed to the user.

9. One or more computer-readable media having computer-usable instructions stored thereon for performing a method for providing ads to requesting applications while the client device is not connected to a communication network, the method comprising:
identifying a plurality of qualified advertisements stored locally on a client machine for an ad request from an application;
calculating an estimated total global impression count for each advertisement within the plurality of qualified advertisements;
comparing an expected impression count of each qualified advertisement to the corresponding estimated total global impression count of the qualified advertisement; and
providing at least one qualified advertisement based on the comparison of the expected impression count to the total global impression count.

10. The media according to claim 9, wherein the identification is based on the requirements of the application's request and one or more business rules associated with each of the plurality of qualified advertisements.

11. The method according to claim 9, further comprising ranking the plurality of qualified advertisements in an order that depends on how far away the estimated total global impression count is from reaching the expected impression count, wherein the qualified advertisements that are furthest away from reaching the expected impression count are ranked higher.

12. The method according to claim 11, further comprising providing the highest ranked advertisement to be displayed to the user.

13. The method according to claim 9, wherein the estimated total global impression count is calculated based on a global impression count of the advertisement, a local impression count of the advertisement, a global view count of the advertisement, and a local view count of the qualified advertisement.

14. The method according to claim 9, wherein the estimated total global impression count is calculated using the following algorithm:
ETGIC=global impression count+(local impression count*(Δglobal view count/Δlocal view count))

15. A system for providing ads to requesting applications while the client device is not connected to a communication network, comprising:
an offline advertisement engine for storing one or more business rules for each of a plurality of corresponding stored advertisements;
an offline advertisement media manager for storing one or more creatives related to the stored advertisements; and
an advertisement center client for receiving requests from an application for at least one advertisement, while the client device is not connected to a communication network, and providing the at least one advertisement and at least one creative associated with the at least one advertisement to the application.

16. The system according to claim 15, wherein the at least one advertisement is provided based on the one or more business rules.

17. The system according to claim 15, wherein at least one of the one or more business rules, the plurality of advertisements, and the one or more creatives are pre-installed with the client device in a first run manifest.

18. The system according to claim 15, wherein the offline advertisement engine stores one or more events associated with a user's interaction with the at least one advertisement provided.

19. The system according to claim 16, wherein the offline advertisement engine stores a local impression count.

20. The system according to claim 15, wherein the offline advertisement engine reports the one or more events and the local impression count to one or more servers when the client device is connected to a communication network.
